(19) United States
(12) Patent Application Publication
(10) Pub. No.: US 2024/0340706 A1
(43) Pub. Date: Oct. 10, 2024

(54) BACKSCATTER COMMUNICATION METHOD, TERMINAL, AND NETWORK SIDE DEVICE

(71) Applicant: VIVO MOBILE COMMUNICATION CO., LTD., Dongguan (CN)

(72) Inventors: Wei HUANG, Dongguan (CN); Dajie JIANG, Dongguan (CN)

(73) Assignee: VIVO MOBILE COMMUNICATION CO., LTD., Dongguan (CN)

(21) Appl. No.: 18/743,074

(22) Filed: Jun. 13, 2024

Related U.S. Application Data
(63) Continuation of application No. PCT/CN2022/138530, filed on Dec. 13, 2022.

(30) Foreign Application Priority Data
Dec. 16, 2021 (CN) 202111547386.4

(51) Int. Cl. H04W 28/18

(52) U.S. Cl. CPC H04W 28/18

(57) ABSTRACT

A backscatter communication method, a terminal, and a network side device are provided. The backscatter communication method includes: A first terminal receives a first signal that is sent by a second terminal through backscattering based on a signal transmission parameter. The first terminal sends a second signal to a network side device. The second signal is obtained based on the first signal.

### CROSS-REFERENCE TO RELATED APPLICATIONS

This application is a continuation of International Application No. PCT/CN2022/138530, filed on Dec. 13, 2022, which claims priority to Chinese Patent Application No. 202111547386.4, filed Dec. 16, 2021. The entire contents of each of the above-identified applications are expressly incorporated herein by reference.

### TECHNICAL FIELD

This application relates to the field of communication technologies, and specifically, to a backscatter communication method, a terminal, and a network side device.

### BACKGROUND

BackScatter Communication (BSC) means that a backscatter communication device uses a radio frequency signal from another device or an environment to perform signal modulation to transmit own information.

After large-scale cellular deployment of BSC terminal devices, to solve a problem that a Radio Frequency (RF) signal undergoes a double near-far effect caused by signal attenuation of a round-trip signal, a bistatic architecture is likely to be deployed. In this case, an RF source and a BSC receiver are separated. For a person skilled in the art, there is an urgent need to implement a specific solution for how to communicate between a BSC terminal and a base station in the bistatic architecture.

### SUMMARY

Embodiments of this application provide a backscatter communication method, a terminal, and a network side device.

According to a first aspect, a backscatter communication method is provided, applied to a first terminal, the method including:
receiving, by a first terminal, a first signal that is sent by a second terminal through backscattering based on a signal transmission parameter; and
sending, by the first terminal, a second signal to a network side device, where the second signal is obtained based on the first signal.

According to a second aspect, a backscatter communication method is provided, applied to a second terminal, the method including:
sending, by a second terminal through backscattering, a first signal to a first terminal based on a signal transmission parameter.

According to a third aspect, a backscatter communication method is provided, applied to a network side device, the method including:
receiving, by a network side device, a second signal sent by a first terminal, where the second signal is obtained by the first terminal based on a first signal sent by a second terminal, and the first signal is sent by the second terminal through backscattering based on a signal transmission parameter; and
performing, by the network side device, target processing on the second signal based on the signal transmission parameter.

According to a fourth aspect, a communication apparatus is provided, including:
a receiving module, configured to receive a first signal that is sent by a second terminal through backscattering based on a signal transmission parameter; and
a sending module, configured to send a second signal to a network side device, where the second signal is obtained based on the first signal.

According to a fifth aspect, a backscatter communication apparatus is provided, including:
a sending module, configured to send, through backscattering, a first signal to a first terminal based on a signal transmission parameter.

According to a sixth aspect, a communication apparatus is provided, including:
a receiving module, configured to receive a second signal sent by a first terminal, where the second signal is obtained by the first terminal based on a first signal sent by a second terminal, and the first signal is sent by the second terminal through backscattering based on a signal transmission parameter; and
a processing module, configured to perform target processing on the second signal based on the signal transmission parameter.

According to a seventh aspect, a first terminal is provided. The first terminal includes a processor and a memory. The memory stores a program or instructions executable on the processor. The program or the instructions, when executed by the processor, implement the steps of the method according to the first aspect.

According to an eighth aspect, a first terminal is provided, including a processor and a communication interface, where the communication interface is configured to receive a first signal that is sent by a second terminal through backscattering based on a signal transmission parameter; and send a second signal to a network side device.

According to a ninth aspect, a second terminal is provided. The second terminal includes a processor and a memory. The memory stores a program or instructions executable on the processor. The program or the instructions, when executed by the processor, implement the steps of the method according to the second aspect.

According to a tenth aspect, a second terminal is provided, including a processor and a communication interface, where the communication interface is configured to send, through backscattering, a first signal to a first terminal based on a signal transmission parameter.

According to an eleventh aspect, a network side device is provided. The network side device includes a processor and a memory. The memory stores a program or instructions executable on the processor. The program or the instructions, when executed by the processor, implement the steps of the method according to the third aspect.

According to a twelfth aspect, a network side device is provided, including a processor and a communication interface. The communication interface is configured to receive a second signal sent by a first terminal, where the second signal is obtained by the first terminal based on a first signal sent by a second terminal, and the first signal is sent by the second terminal through backscattering based on a signal transmission parameter; and the processor is configured to perform target processing on the second signal based on the signal transmission parameter.

According to a thirteenth aspect, a backscatter communication system is provided, including: a first terminal, a second terminal, and a network side device. The first terminal may be configured to perform the steps of the backscatter communication method according to the first aspect. The second terminal may be configured to perform the steps of the backscatter communication method according to the second aspect. The network side device may be configured to perform the steps of the backscatter communication method according to the third aspect.

According to a fourteenth aspect, a readable storage medium is provided, where the readable storage medium stores a program or instructions, and the program or the instructions, when executed by a processor, implement the steps of the method according to the first aspect, or implement the steps of the method according to the second aspect, or implement the steps of the method according to the third aspect.

According to a fifteenth aspect, a chip is provided, where the chip includes a processor and a communication interface, the communication interface is coupled to the processor, and the processor is configured to run a program or instructions, to implement the method according to the first aspect, or implement the method according to the second aspect, or implement the method according to the third aspect.

According to a sixteenth aspect, a computer program/program product is provided, where the computer program/program product is stored in a storage medium, and the computer program/program product is executed by at least one processor to implement the steps of the backscatter communication method according to the first aspect, the second aspect, or the third aspect.

In embodiments of this application, the first terminal receives the first signal that is sent by the second terminal through backscattering based on the signal transmission parameter. The first terminal sends the second signal to the network side device. In other words, the second terminal performing backscattering can communicate with other devices. The second signal is obtained based on the first signal.

### BRIEF DESCRIPTION OF THE DRAWINGS

FIG. 1 is a structural diagram of a wireless communication system according to an embodiment of this application;

FIG. 2 is a schematic principle diagram of backscatter communication according to an embodiment of this application;

FIG. 3 is a schematic diagram of an MBCS according to an embodiment of this application;

FIG. 4 is a schematic diagram of a BBCS according to an embodiment of this application;

FIG. 5 is a first schematic diagram of a backscatter communication cellular networking architecture according to an embodiment of this application;

FIG. 6 is a second schematic diagram of a backscatter communication cellular networking architecture according to an embodiment of this application;

FIG. 7 is a third schematic diagram of a backscatter communication cellular networking architecture according to an embodiment of this application;

FIG. 8 is a fourth schematic diagram of a backscatter communication cellular networking architecture according to an embodiment of this application;

FIG. 9 is a fifth schematic diagram of a backscatter communication cellular networking architecture according to an embodiment of this application;

FIG. 10 is a sixth schematic diagram of a backscatter communication cellular networking architecture according to an embodiment of this application;

FIG. 11 is a first schematic flowchart of a backscatter communication method according to an embodiment of this application;

FIG. 12 is a first schematic scenario diagram of a backscatter communication method according to an embodiment of this application;

FIG. 13 is a second schematic scenario diagram of a backscatter communication method according to an embodiment of this application;

FIG. 14 is a third schematic scenario diagram of a backscatter communication method according to an embodiment of this application;

FIG. 15 is a first schematic diagram of an interaction process of a backscatter communication method according to an embodiment of this application;

FIG. 16 is a fourth schematic scenario diagram of a backscatter communication method according to an embodiment of this application;

FIG. 17 is a second flowchart of a backscatter communication method according to an embodiment of this application;

FIG. 18 is a fifth schematic scenario diagram of a backscatter communication method according to an embodiment of this application;

FIG. 19 is a first block diagram of a communication apparatus according to an embodiment of this application;

FIG. 20 is a second block diagram of a backscatter communication apparatus according to an embodiment of this application;

FIG. 21 is a third block diagram of a communication apparatus according to an embodiment of this application;

FIG. 22 is a block diagram of a communication device according to an embodiment of this application;

FIG. 23 is a block diagram of a hardware structure of a terminal according to an embodiment of this application; and

FIG. 24 is a block diagram of a network side device according to an embodiment of this application.

### DETAILED DESCRIPTION

The embodiments of this application are described below with reference to the accompanying drawings in embodiments of this application. Apparently, the described embodiments are some rather than all of embodiments of this application. All other embodiments obtained by a person of ordinary skill in the art based on embodiments of this application fall within the protection scope of this application.

The specification and claims of this application, and terms “first” and “second” are used to distinguish similar objects, but are not used to describe a specific sequence or order. It should be understood that the terms so used are interchangeable under appropriate circumstances such that embodiments of this application are capable of being practiced in other sequences than those illustrated or described herein, and that the objects distinguished by “first” and “second” are generally a class and do not limit the number of objects, e.g., the first object may be one or more. In addition, “and/or” in the description and claims represents at least one of connected objects, and the character “/” generally indicates an “or” relationship between associated objects.

It should be noted that the technologies described in embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), and other systems. The terms “system” and “network” may be used interchangeably in embodiments of this application. The technology described can be applied to the systems and radio technologies described above, and can also be applied to other systems and radio technologies. The following description describes a New Radio (NR) system for illustrative purposes, and NR terminology is used in most of the description below. These technologies are also applicable to applications other than NR system applications, for example, the 6^{th} Generation (6G) communication system.

FIG. 1 is a block diagram of a wireless communication system to which an embodiment of this application can be applied. The communication system includes terminals 11 and a network side device 12. The terminal 11 may be a terminal side device such as a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart home (home equipment with wireless communication functions, such as a refrigerator, a TV, a washing machine, or furniture), a game console, a personal computer, a teller machine, or a self-service machine. The wearable device includes: a smart watch, a smart band, smart headphones, smart glasses, smart jewelry (a smart bracelet, a smart bracelet, a smart ring, a smart necklace, a smart anklet, a smart anklet, and the like), a smart wristband, smart clothing, and the like. It should be noted that in embodiments of this application, a specific type of the terminal 11 is not limited. The network side device 12 may include an access network device or a core network device, where the access network device 12 may also be referred to as a radio access network device, a Radio Access Network (RAN), a radio access network function, or a radio access network unit. The access network device 12 may include a base station, a Wireless Local Area Network (WLAN) access point, a Wireless Fidelity (WiFi) node, or the like. The base station may be referred to as a Node B, an evolved Node B (eNB), an access point, a Base Transceiver Station (BTS), a radio base station, a radio transceiver, a Basic Service Set (BSS), an Extended Service Set (ESS), a Home Node B, a Home evolved Node B, a Transmitting Receiving Point (TRP), or another suitable term in the field. As long as the same technical effect is achieved, the base station is not limited to a specific technical vocabulary. It should be noted that, only a base station in an NR system is used as an example in embodiments of this application, and the specific type of the base station is not limited.

The method according to embodiments of this application may be applied to backscatter communication terminals, including, for example, a tag in conventional Radio Frequency IDentification (RFID) and an Internet of Things (IoT) device.

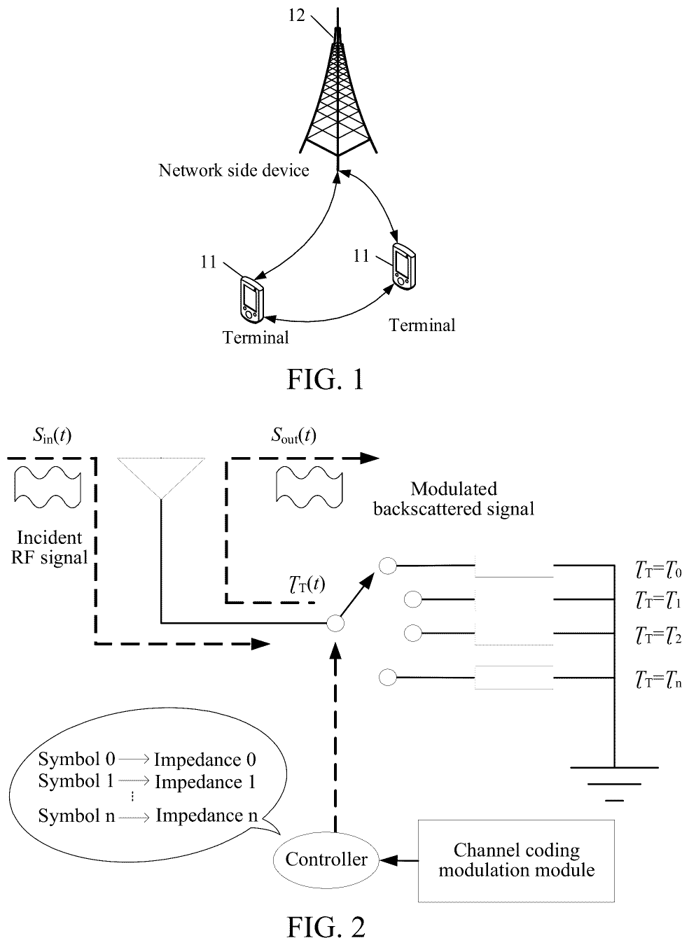

Backscatter communication means that a backscatter communication device uses a radio frequency signal from another device or an environment to perform signal modulation to transmit own information. A modulation circuit of the backscatter communication device is shown in FIG. 2. The backscatter communication device controls a reflection coefficient Γ of the circuit by adjusting internal impedances of the backscatter communication device, to change an amplitude, a frequency, a phase, and the like of an incident signal, implementing signal modulation. The reflection coefficient of the signal may be represented by:

$$Γ = \frac{{Z}_{1} - {Z}_{0}}{{Z}_{1} + {Z}_{0}} = \vert Γ \vert {e}^{j {θ}_{T}}$$

Z₀ is an antenna characteristic impedance and Z₁ is a load impedance. Assuming that the incident signal is Sᵢₙ(t), an output signal is Sₒᵤₜ(t)=Sᵢₙ(t)|Γ|e^{jθ}^{_{T}}. Therefore, corresponding amplitude modulation, frequency modulation, or phase modulation can be implemented by properly controlling the reflection coefficient.

From the perspective of a manner of controlling or changing the load impedance Z₁, backscatter communication is divided into backscatter communication based on analog modulation and backscatter communication based on digital modulation. In backscatter communication based on analog modulation, the load impedance Z₁ is changed by adjusting a built-in analog circuit, and the circuit is adjusted in a continuous manner. Therefore, the adjustable reflection coefficient of the circuit can be adjusted with high precision. As shown in FIG. 2, in backscatter communication based on digital modulation, several pre-built-in load impedances are available for selection, and one of the load impedances is selected by a controller to change the reflection coefficient. Therefore, precision of the reflection coefficient of digital modulation is strongly related to a quantity of built-in load impedances.

Based on this, the backscatter communication device may be a Tag in a conventional RFID system, a Passive/Semi-Passive IoT device, or an independent Reconfigurable Intelligent Surface (RIS) in an intelligent metasurface. For convenience, such backscatter communication devices are collectively referred to as BSC terminals in embodiments of this application.

For the architecture of backscatter communication, there are three types of backscatter communication systems: Monostatic Backscatter Communication Systems (MBCSs), Bistatic Backscatter Communication Systems (BBCSs), and Ambient Backscatter Communication Systems (ABCSs).

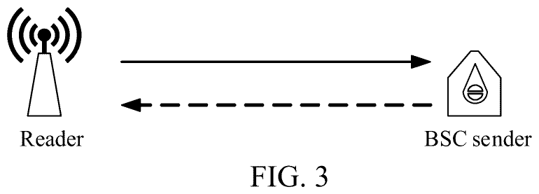

FIG. 3 shows an MBCS. For example, the conventional RFID system is a typical MBCS. The system includes a BSC sender (for example, a Tag) and a Reader. The Reader includes an RF source and a BSC receiver. The RF source is configured to generate an RF signal to power the BSC sender/Tag. The BSC sender backscatters the modulated RF signal, and the BSC receiver in the Reader receives and demodulates the backscattered signal. Because the RF source and BSC receiver are in the same device, for example, in the Reader, this system is a monostatic backscatter communication system. In the MBCS system, because the RF signal sent from the BSC sender undergoes a double near-far effect caused by signal attenuation of a round-trip signal, signal energy attenuation is large. Therefore, the MBCS system is generally used for short-distance backscatter communication, for example, conventional RFID applications.

Different from the MBCS system, an RF source and a BSC receiver in a BBCS system are separated. FIG. 4 is a schematic diagram of a BBCS system. Therefore, the BBCS avoids the problem of large attenuation of a round-trip signal. In addition, performance of the BBCS communication system can be further improved by properly placing the RF source. Similar to the BBCS system, an RF source and a BSC receiver in an ABCS system are also separated. However, different from the BBCS system in which the radio frequency source is a dedicated signal radio frequency source, the radio frequency source in the ABCS system may be a radio frequency source in an available environment, for example, a TV tower, a cellular base station, a WiFi signal, or a Bluetooth signal.

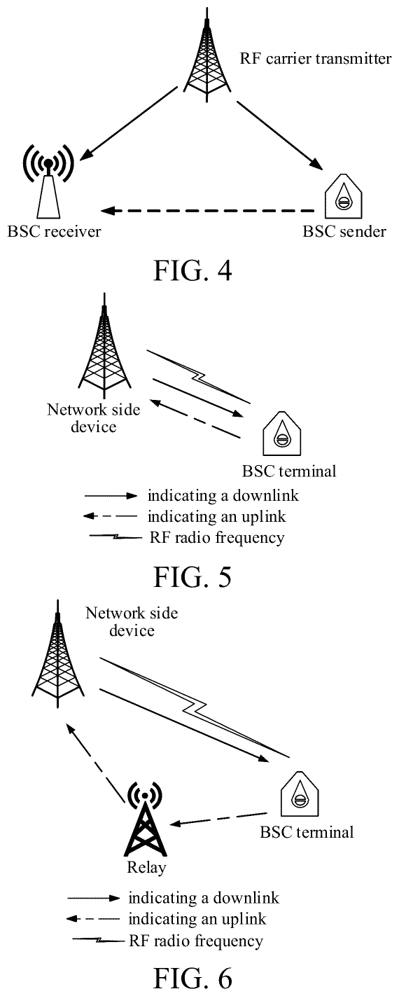

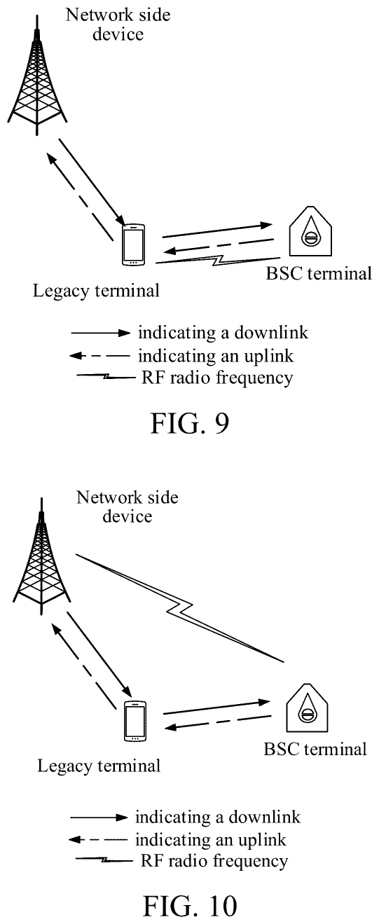

In a case of large-scale cellular deployment of backscatter communication terminal devices, backscatter communication cellular networking architectures may be divided into six architectures as shown in FIG. 5 to FIG. 10 based on differences in radio frequency sources, uplink data transmission, and downlink data transmission.

In an architecture 1 shown in FIG. 5, a network side device is a radio frequency source, and is also a downlink data sender of a BSC terminal and an uplink data receiver of the BSC terminal. In other words, the network side device directly communicates with the BSC terminal in this case. Such an architecture has high requirements on receiving sensitivity of the network side device and the BSC terminal, but is simple to deploy.

In an architecture 2 shown in FIG. 6, a network side device is also a radio frequency source. However, in this case, there is a Helper or a Relay, which is configured to relay uplink data from a BSC terminal to the network side device. Certainly, the Helper or the Relay may also relay downlink data from the network side device to the BSC terminal, which will not be described herein.

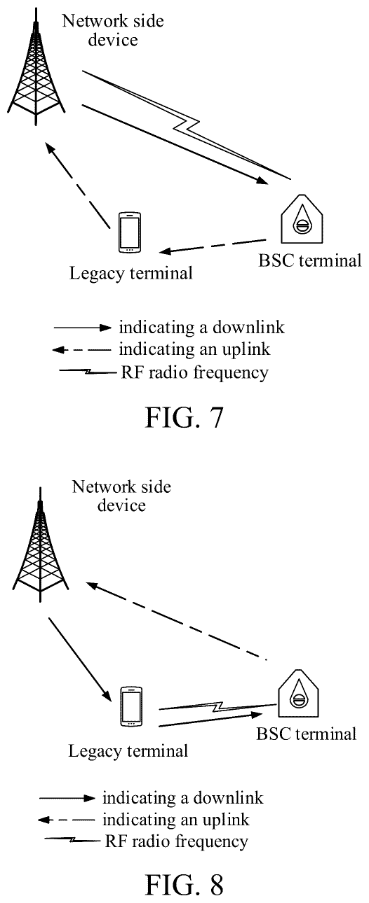

In an architecture 3 to an architecture 6 shown in FIG. 7 to FIG. 10, existing or legacy (Legacy) terminals are used as radio frequency sources, or used for forwarding downlink data, or used for forwarding uplink data, and so on. In the architecture 3, a network side device is a radio frequency source. The network side device directly transmits downlink data to a BSC terminal. In uplink transmission, the BSC terminal first backscatters data to a Legacy terminal, and then the Legacy terminal forwards the data to the network side device. In an architecture 4, a radio frequency source is a terminal. Downlink data is first sent by the network side device to a legacy terminal, and then forwarded by the legacy terminal to a BSC terminal. In uplink transmission, the BSC terminal directly transmits a signal to the network side device in the reverse direction. In an architecture 5, a radio frequency source is a terminal. Downlink data is first sent by a network side device to a Legacy terminal, and then forwarded by the Legacy terminal to a BSC terminal. In uplink transmission, the BSC terminal first backscatters data to the Legacy terminal, and then the Legacy terminal forwards the data to the network side device. In an architecture 6, a radio frequency source is a network side device. Downlink data is first sent by the network side device to a Legacy terminal, and then forwarded by the Legacy terminal to a BSC terminal. In uplink transmission, the BSC terminal first backscatters data to the Legacy terminal, and then the Legacy terminal forwards the data to the network side device.

The Legacy terminals may also be referred to as conventional terminals or ordinary terminals, such as existing mobile phones, in-vehicle devices, Customer Premise Equipment (CPE), and other terminals with normal hardware capabilities.

In an embodiment, according to the backscatter communication solution, a signal transmission parameter for backscattering and a method for carrying indication information of the signal transmission parameter are designed to support a BSC terminal in using a signal backscattered by a radio frequency source for signal modulation, and in bistatic backscatter communication in which a Legacy terminal or a Relay/Helper is used as a relay to transmit uplink data to a network side device, the relay terminal/Helper can demodulate a modulated signal of the BSC terminal based on the indication information, thereby solving a problem of weak uplink coverage of the BSC terminal. It should be noted that although the following embodiments are described using a Legacy relay terminal as an example, the same solution can be extended to conventional relay base station or Helper scenarios.

The backscatter communication method provided in embodiments of this application is described in detail below with reference to the accompanying drawings by using some embodiments and application scenarios.

In the following embodiment, an example in which a first terminal is a Legacy terminal and a second terminal is a BSC terminal is used for description.

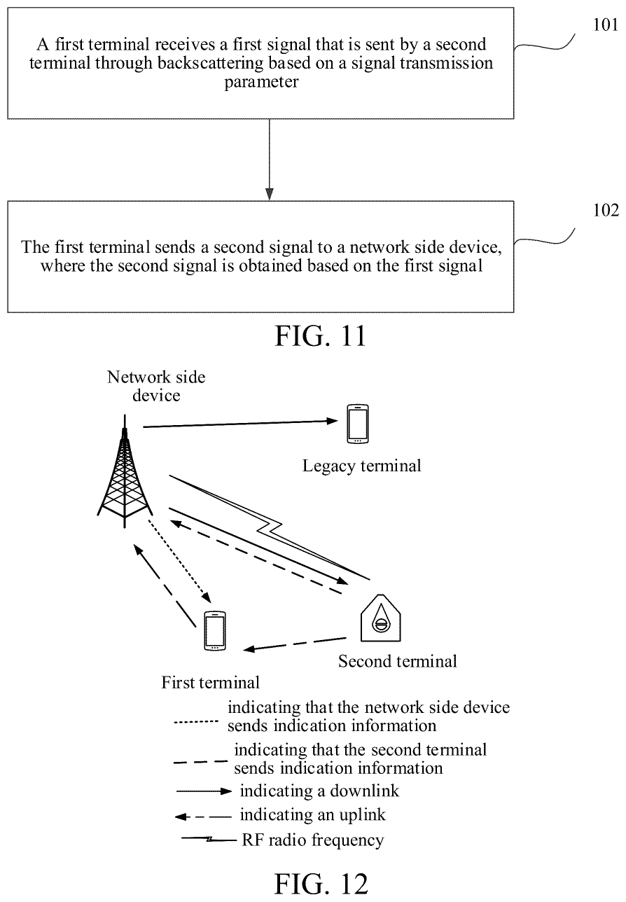

FIG. 11 is a first schematic flowchart of a backscatter communication method according to an embodiment of this application. As shown in FIG. 11, the method according to this embodiment includes the following steps:

Step 101: A first terminal receives a first signal that is sent by a second terminal through backscattering based on a signal transmission parameter.

In some implementations, the foregoing system architectures shown in FIG. 6 to FIG. 10 may be used for the method according to this embodiment. The first terminal receives the first signal sent by the second terminal. The first signal is a signal sent through backscattering based on the signal transmission parameter.

The signal transmission parameter may be determined by the first terminal, or obtained from the second terminal or a network side device.

Step 102: The first terminal sends a second signal to the network side device, where the second signal is obtained based on the first signal.

In some implementations, after receiving the first signal, the first terminal forwards the first signal, or processes the first signal to obtain the second signal, and sends the second signal to the network side device.

According to the method in this embodiment, the first terminal receives the first signal that is sent by the second terminal through backscattering based on the signal transmission parameter. The first terminal sends the second signal to the network side device. In other words, the second terminal performing backscattering can communicate with other devices. The second signal is obtained based on the first signal. According to the foregoing solution, communication between a BSC terminal, a relay terminal, and a base station in a bistatic backscatter communication architecture is implemented.

In some implementations, the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, a preamble sequence, synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the time domain resource includes, for example, a slot or a symbol, and the frequency domain resource includes, for example, carrier frequency information, a carrier frequency band, a Band Width Part (BWP), or a Resource Block (RB).

The time window indicates the time window in which the first signal is sent, for example, how long it takes for the second terminal to send the first signal after receiving indication information carrying the signal transmission parameter.

The time information of the signal transmission within the transmission periodicity includes, for example, a time range or duration of the signal transmission, duration of non-transmission, or a proportion of the duration of the signal transmission or the non-transmission. For example, the transmission periodicity is 10 ms, and one transmission periodicity includes signal transmission time of the second terminal, for example, 5 ms, and non-transmission time, for example, 5 ms, where during the non-transmission time, the second terminal can perform operations such as energy collection or energy saving.

The periodicity length information includes at least one of the following: one or more periodicity lengths for a modulated signal, a length of a subframe or a slot, a quantity of symbols included in a subframe or a slot, or the like.

The synchronization information includes at least one of the following: starting time of a subframe or a symbol of the first signal, or information about an offset between a timing of the first signal and a timing of the network side device.

The parameter information for frequency shifting the first signal includes whether frequency shift is supported, a center frequency and bandwidth of frequency shifting, and the like.

The transmission identifier indicates whether the first signal is transmitted in one periodicity or a plurality of periodicities, thereby indicating whether a receiver performs buffering processing or does not need buffering processing. In some implementations, the transmission in the plurality of periodicities may be intermittent transmission in the plurality of periodicities.

The total transmission duration indicates how many periodicity lengths the total duration for transmission of the first signal is. In some implementations, the total transmission duration may further include: a receiver energy saving and buffering indication, indicating that the receiver does not need to receive signals when not transmitting signals, to reduce power consumption, or performs buffering processing when the total duration is a plurality of periodicity lengths.

The coding method indicates a channel coding method and/or a baseband coding method used for signal transmission.

In some implementations, step 102 may be implemented in the following manner:

The first terminal demodulates and decodes the first signal based on the signal transmission parameter to obtain a third signal, modulates and encodes the third signal to generate the second signal, and sends the second signal to the network side device; or
the first terminal amplifies the first signal to obtain the second signal, and sends the second signal to the network side device.

In some implementations, based on the received signal transmission parameter corresponding to the second terminal, the first terminal receives the first signal sent by the second terminal and demodulates and decodes the first signal, modulates and encodes the third signal obtained through demodulation and decoding to generate the second signal, and sends the second signal to the network side device. Because the first terminal demodulates and decodes the first signal, reliability of the signal transmission is high.

In some implementations, the first terminal sends the signal of the second terminal in an amplified and forwarded manner, that is, amplifies the first signal to obtain the second signal, and sends the second signal to the network side device.

In the foregoing implementation, the second signal sent by the first terminal to the network side device may be generated based on the first signal through amplification or parsing and then re-modulation and encoding. This is highly flexible, and the second signal generated through re-parsing is more reliable.

In an embodiment, the first terminal obtains the signal transmission parameter in at least one of the following manners:
the first terminal receives first indication information sent by the network side device, where the first indication information indicates the signal transmission parameter to the first terminal; or
the first terminal receives second indication information sent by the network side device, where the second indication information indicates the signal transmission parameter to the second terminal, and the second indication information is information that both the first terminal and the second terminal can demodulate; or
the first terminal receives third indication information sent by the second terminal, where the third indication information indicates the signal transmission parameter to the first terminal; or
the first terminal determines the signal transmission parameter.

In some implementations, the first terminal may obtain the signal transmission parameter based on the indication information of the network side device, or obtain the signal transmission parameter based on the third indication information of the second terminal, or determine the signal transmission parameter by itself.

The obtaining the signal transmission parameter based on the indication information of the network side device includes the following cases:

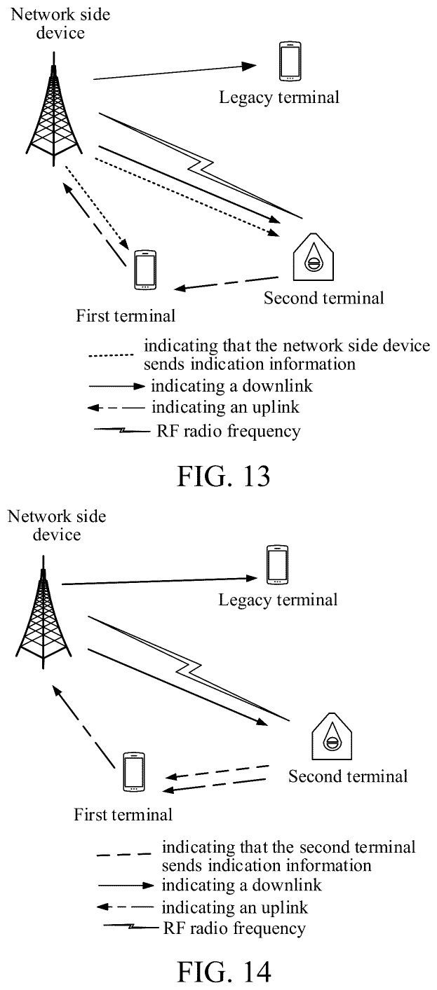

The signal transmission parameter is obtained based on the first indication information sent by the network side device, where the first indication information is specifically used to be sent to the first terminal, and as shown in FIG. 12, the signal transmission parameter may be determined by the network side device or may be sent by the second terminal to the network side device based on the indication information; or
the signal transmission parameter is obtained based on the second indication information sent by the network side device. Both the first terminal and the second terminal can parse the second indication information. For example, the second indication information sent by the network side device to the second terminal already includes the signal transmission parameter that the first terminal needs to obtain, and not only the second terminal can demodulate the second indication information, but the first terminal can also demodulate the second indication information, as shown in FIG. 13.

As shown in FIG. 14, the first terminal receives the third indication information sent by the second terminal, and obtains the signal transmission parameter based on the third indication information.

In the foregoing implementation, the first terminal can obtain the signal transmission parameter in various manners. This is highly flexible, and implementation complexity is low.

In some implementations, the first indication information or the second indication information is carried in at least one of the following:
Downlink Control Information (DCI);
a preamble sequence;
Radio Resource Control (RRC) signaling; or
a Media Access Control Control Element (MAC CE).

The DCI may be DCI in an existing format with extended functions, or newly designed DCI in a new format, which is not limited in embodiments of this application.

In some implementations, the third indication information is carried in at least one of the following:
two-step Sidelink Control Information (SCI);
one-step SCI;
a preamble sequence;
sidelink SL RRC signaling; or
a sidelink SL MAC CE.

The third indication information is used by the second terminal to indicate the signal transmission parameter to the first terminal. In some implementations, the second terminal reports the signal transmission parameter to the first terminal through an interface similar to a PC5 interface in a sidelink SL.

The two-step SCI may reuse current two-step SCI to carry the transmitted indication information. A 2nd-stage SCI format field is extended in 1st stage SCI, so that the two-step SCI supports the newly defined 2nd stage SCI format between the second terminal and the first terminal, and the newly designed 2nd stage format includes an identifier ID of the first terminal, an identifier ID of the second terminal, indication information of the signal transmission parameter, and the like.

Because the current two-step SCI format is designed for a PC5 interface between Legacy terminals, whether for 1st stage SCI or 2nd stage SCI, signaling overhead is large. Moreover, the design of the two-step SCI is difficult to implement for BSC terminals.

Therefore, a new SCI format may be further designed to carry the transmitted indication information. In some implementations, the newly designed SCI may be one-step SCI, and the SCI carries at least the identifier ID of the first terminal, the identifier ID of the second terminal, indication information of the signal transmission parameter, resource information, and the like.

In an embodiment, the second terminal is powered in at least one of the following manners:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

In some implementations, a power supply source and a radio frequency source may be the same device (for example, both are the network side device), or may be different devices.

The second terminal may be powered by the radio frequency signal of the network side device, or the second terminal may be powered by another radio frequency signal.

The second terminal is powered by a non-radio frequency signal, including but not limited to a mechanical power supply, a vibration power supply, solar energy, thermal energy, and the like.

In the foregoing implementation, the second terminal can be powered in various manners. This is highly flexible, and can increase reliability of the device.

In an embodiment, both the second terminal and the first terminal are within the coverage of the network side device, and the second terminal has a capability to receive and parse indication information sent by the network side device. Meanwhile, signaling interaction and data transmission may be performed between the first terminal and the second terminal through PC5-like interfaces. As shown in FIG. 12 or FIG. 13, in this scenario, the signal transmission parameter transmitted by the second terminal to the first terminal may be indicated to the first terminal by the network side device through indication information. For a method for carrying the indication information, refer to the foregoing embodiments. For example, the following manners may be included:

Manner 1: As shown in FIG. 13, the second indication information sent by the network side device to the second terminal already includes the signal transmission parameter transmitted in the reverse direction by the second terminal to the first terminal. Not only can the second terminal parse the second indication information, the first terminal can also parse the second indication information. In this solution, the first terminal can obtain the signal transmission parameter without the need for the network side device to separately send the indication information to the first terminal.

Manner 2: As shown in FIG. 12, the network side device separately sends the first indication information including the signal transmission parameter that is transmitted in the reverse direction by the second terminal to the first terminal, where the first indication information and the indication information (for example, the second indication information) that is sent by the network side device to the second terminal are not the same indication information.

Manner 3: As shown in FIG. 12, the network side device does not learn of the signal transmission parameter that is transmitted in the reverse direction by the second terminal to the first terminal. The second terminal first reports own signal transmission parameter to the network side device, and then the network side device notifies the first terminal through the indication information.

In another embodiment, as shown in FIG. 16, the second terminal and the first terminal are both within or outside the coverage of the base station, and the second terminal has the capability to receive and parse indication information sent by the network side device. Meanwhile, signaling interaction and data transmission may be performed between the first terminal and the second terminal through PC5-like interfaces. In this scenario, because the first terminal has strong terminal capabilities, the first terminal can serve as a master UE (Master UE) and allocate transmission resources and transmission indication information to other second terminals in a group where the master UE is located, and send signal transmission parameter indication information of the second terminal to the second terminal through an interface similar to a PC5 interface in an SL.

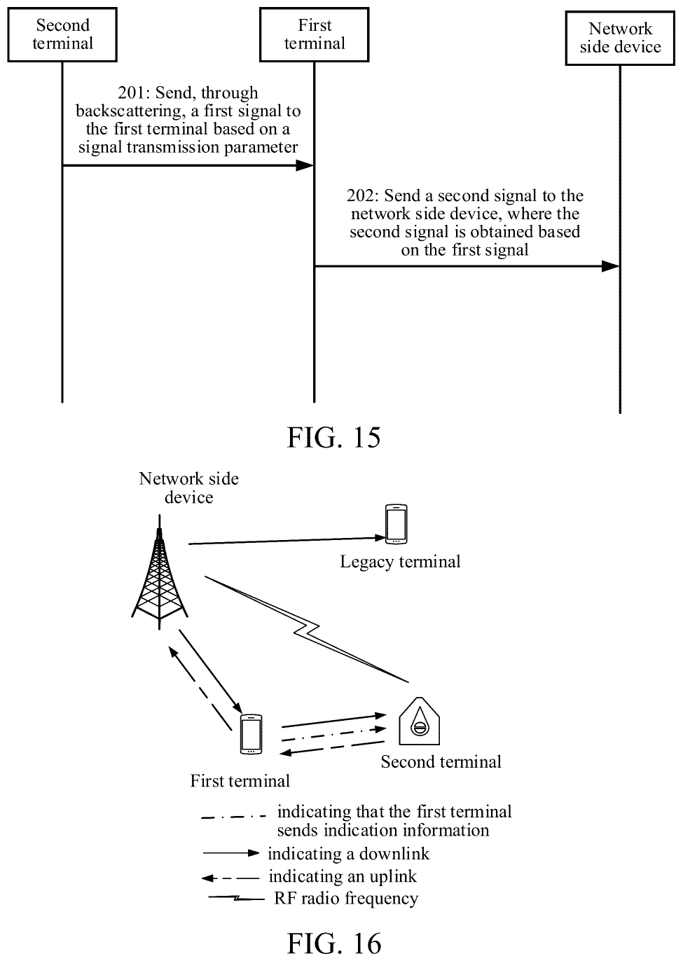

FIG. 15 is a first schematic diagram of an interaction process of a backscatter communication method according to an embodiment of this application. As shown in FIG. 15, the method according to this embodiment includes the following steps:

Step 201: A second terminal sends, through backscattering, a first signal to a first terminal based on a signal transmission parameter.

Step 202: The first terminal sends a second signal to a network side device, where the second signal is obtained based on the first signal.

In some implementations, the method further includes:
obtaining, by the second terminal, the signal transmission parameter. In some implementations, the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, periodicity length information of a preamble sequence, synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the obtaining, by the second terminal, the signal transmission parameter includes:
obtaining, by the second terminal, the signal transmission parameter in at least one of the following manners:
receiving, by the second terminal, second indication information sent by the network side device, where the second indication information indicates the signal transmission parameter to the second terminal, and the second indication information is information that both the first terminal and the second terminal can demodulate; or
receiving, by the second terminal, fourth indication information sent by the first terminal, where the fourth indication information indicates the signal transmission parameter to the second terminal; or
determining, by the second terminal, the signal transmission parameter.

In some implementations, the second terminal may obtain the signal transmission parameter based on the indication information sent by the network side device, or obtain the signal transmission parameter based on the indication information sent by the first terminal, or determine the signal transmission parameter by itself.

As shown in FIG. 16, the second terminal receives the fourth indication information sent by the first terminal, where the fourth indication information indicates the signal transmission parameter.

In some implementations, as shown in FIG. 14, the method further includes the following steps:
sending, by the second terminal, third indication information to the first terminal, where the third indication information indicates the signal transmission parameter to the first terminal.

In some implementations, the second indication information is carried in at least one of the following:
downlink control information DCI;
a preamble sequence;
radio resource control RRC signaling; or
a media access control control element MAC CE.

In some implementations, the third indication information is carried in at least one of the following:
two-step sidelink control information SCI;
one-step SCI;
a preamble sequence;
sidelink SL RRC signaling; or
a sidelink SL MAC CE.

In some implementations, the fourth indication information is carried in at least one of the following:
two-step sidelink control information SCI;
one-step SCI;
a preamble sequence;
sidelink SL RRC signaling; or
a sidelink SL MAC CE.

In some implementations, the second terminal is powered in at least one of the following manners:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

The specific implementation process and technical effects of the method in this embodiment are similar to those in the first terminal-side method embodiments. For details, refer to the detailed description in the first terminal-side method embodiment, which are not repeated herein.

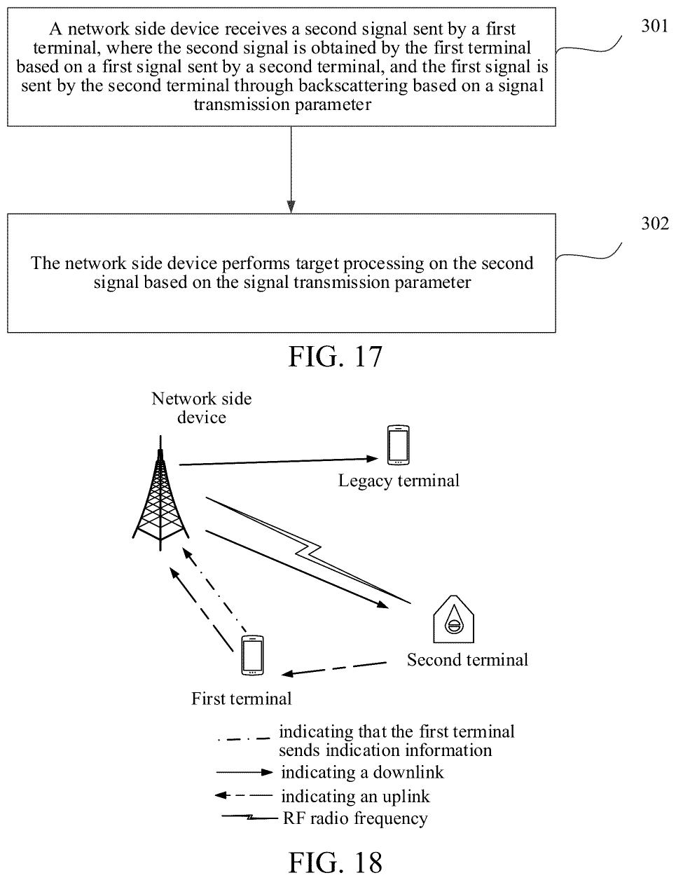

FIG. 17 is a second schematic flowchart of a backscatter communication method according to an embodiment of this application. As shown in FIG. 17, the method according to this embodiment includes the following steps:

Step 301: A network side device receives a second signal sent by a first terminal, where the second signal is obtained by the first terminal based on a first signal sent by a second terminal, and the first signal is sent by the second terminal through backscattering based on a signal transmission parameter.

Step 302: The network side device performs target processing on the second signal based on the signal transmission parameter.

The target processing is, for example, demodulating and decoding the second signal.

In some implementations, the method further includes:
obtaining, by the network side device, the signal transmission parameter, where in some implementations, the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, periodicity length information of a preamble sequence, synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the obtaining, by the network side device, the signal transmission parameter includes:
obtaining the signal transmission parameter in at least one of the following manners:
receiving, by the network side device, fifth indication information sent by the second terminal, where the fifth indication information indicates the signal transmission parameter to the network side device; or
receiving, by the network side device, sixth indication information sent by the first terminal, where the sixth indication information indicates the signal transmission parameter to the network side device; or
determining, by the network side device, the signal transmission parameter.

In some implementations, the network side device may obtain the signal transmission parameter based on the indication information sent by the second terminal (as shown in FIG. 18), or obtain the signal transmission parameter based on the indication information sent by the first terminal (as shown in FIG. 12), or determine the signal transmission parameter by itself.

In some implementations, the method further includes:
sending, by the network side device, first indication information to the first terminal, where the first indication information indicates the signal transmission parameter to the first terminal; or
sending, by the network side device, second indication information to the second terminal, where the second indication information indicates the signal transmission parameter to the second terminal; or
sending, by the network side device, second indication information to the first terminal, where the second indication information indicates the signal transmission parameter to the first terminal.

In some implementations, before the network side device sends the first indication information, the signal transmission parameter may be determined or the fifth indication information may be received. Before the network side device sends the second indication information, the signal transmission parameter may be determined or the sixth indication information may be received.

In some implementations, the first indication information or the second indication information is carried in at least one of the following:
downlink control information DCI;
a preamble sequence;
radio resource control RRC signaling; or
a media access control control element MAC CE.

In some implementations, the fifth indication information or the sixth indication information is carried in at least one of the following:
two-step sidelink control information SCI;
one-step SCI;
a preamble sequence;
sidelink SL RRC signaling; or
a sidelink SL MAC CE.

The backscatter communication method according to embodiments of this application may be performed by a backscatter communication apparatus. In this embodiment of this application, the backscatter communication apparatus provided in embodiments of this application is described by taking the backscatter communication method performed by the backscatter communication apparatus as an example.

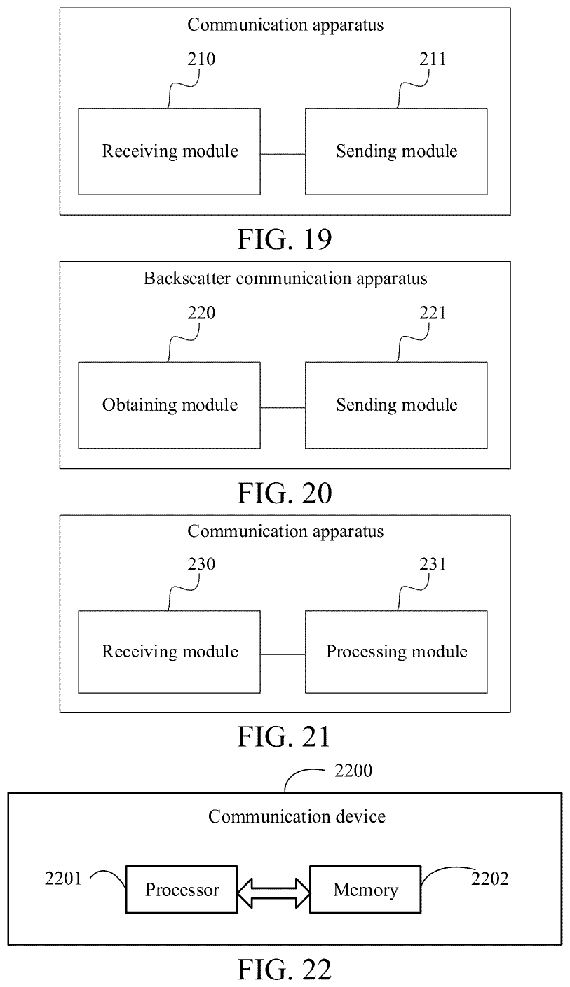

FIG. 19 is a first schematic structural diagram of a communication apparatus according to this application. As shown in FIG. 19, the communication apparatus according to this embodiment includes:
a receiving module 210, configured to receive a first signal that is sent by a second terminal through backscattering based on a signal transmission parameter; and
a sending module 211, configured to send a second signal to a network side device, where the second signal is obtained based on the first signal.

According to the apparatus in this embodiment, the receiving module receives the first signal that is sent by the second terminal through backscattering based on the signal transmission parameter. The sending module sends the second signal to the network side device. In other words, the second terminal performing backscattering can communicate with other devices. The second signal is obtained based on the first signal. According to the foregoing solution, communication between a BSC terminal, a relay terminal, and a base station in a bistatic backscatter communication architecture is implemented.

In some implementations, the apparatus further includes:
an obtaining module, configured to obtain the signal transmission parameter, where the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, preamble sequence synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes at least one of the following: starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the obtaining module is further configured to:
obtain the signal transmission parameter in at least one of the following manners:
receiving first indication information sent by the network side device, where the first indication information indicates the signal transmission parameter to the first terminal; or
receiving second indication information sent by the network side device, where the second indication information indicates the signal transmission parameter to the second terminal, and the second indication information is information that both the first terminal and the second terminal can demodulate; or
receiving third indication information sent by the second terminal, where the third indication information indicates the signal transmission parameter to the first terminal; or
determining the signal transmission parameter.

In some implementations, the first indication information or the second indication information is carried in at least one of the following:
downlink control information DCI;
a preamble sequence;
radio resource control RRC signaling; or
a media access control control element MAC CE.

In some implementations, the third indication information is carried in at least one of the following:
two-step sidelink control information SCI;
one-step SCI;
a preamble sequence;
sidelink SL RRC signaling; or
a sidelink SL MAC CE.

In some implementations, the sending module 211 is further configured to:
demodulate and decode the first signal based on the signal transmission parameter, modulate and encode the decoded signal to generate the second signal, and send the second signal to the network side device; or
amplify the first signal to obtain the second signal, and send the second signal to the network side device.

In some implementations, the second terminal is powered in at least one of the following manners:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

The apparatus according to this embodiment can be used to perform the method in any one of the foregoing first terminal-side method embodiments. The specific implementation process and technical effects of the apparatus in this embodiment are similar to those in the first terminal-side method embodiments. For details, refer to the detailed description in the first terminal-side method embodiment, which are not repeated herein.

FIG. 20 is a second schematic structural diagram of a backscatter communication apparatus according to this application. As shown in FIG. 20, the backscatter communication apparatus according to this embodiment includes:
a sending module 220, configured to send, through backscattering, a first signal to a first terminal based on a signal transmission parameter.

According to the apparatus in this embodiment, the sending module sends, through backscattering, the first signal to the first terminal based on the signal transmission parameter. The first terminal receives the first signal sent by the sending module through backscattering based on the signal transmission parameter, and sends a second signal to a network side device. In other words, the backscatter communication apparatus can communicate with other devices. The second signal is obtained based on the first signal. According to the foregoing solution, communication between a BSC terminal, a relay terminal, and a base station in a bistatic backscatter communication architecture is implemented.

In some implementations, the apparatus further includes: an obtaining module 210, configured to obtain the signal transmission parameter, where in some implementations, the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, periodicity length information of a preamble sequence, synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the obtaining module 210 is further configured to:
obtain the signal transmission parameter in at least one of the following manners:
receiving second indication information sent by the network side device, where the second indication information indicates the signal transmission parameter to the second terminal, and the second indication information is information that both the first terminal and the second terminal can demodulate; or
receiving fourth indication information sent by the first terminal, where the fourth indication information indicates the signal transmission parameter to the second terminal; or
determining the signal transmission parameter.

In some implementations, the sending module 220 is further configured to:
send third indication information to the first terminal, where the third indication information indicates the signal transmission parameter to the first terminal.

In some implementations, the second indication information is carried in at least one of the following:
downlink control information DCI;
a preamble sequence;
radio resource control RRC signaling; or
a media access control control element MAC CE.

In some implementations, the third indication information is carried in at least one of the following:
two-step sidelink control information SCI;
one-step SCI;
a preamble sequence;
sidelink SL RRC signaling; or
a sidelink SL MAC CE.

In some implementations, the fourth indication information is carried in at least one of the following:
two-step sidelink control information SCI;
one-step SCI;
a preamble sequence;
sidelink SL RRC signaling; or
a sidelink SL MAC CE.

In some implementations, the second terminal is powered in at least one of the following manners:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

The apparatus according to this embodiment can be used to perform the method in any one of the foregoing second terminal-side method embodiments. The specific implementation process and technical effects of the apparatus in this embodiment are similar to those in the second terminal-side method embodiments. For details, refer to the detailed description in the second terminal-side method embodiment, which are not repeated herein.

FIG. 21 is a third schematic structural diagram of a communication apparatus according to this application. As shown in FIG. 21, the communication apparatus according to this embodiment includes:
a receiving module 230, configured to receive a second signal sent by a first terminal, where the second signal is obtained by the first terminal based on a first signal sent by a second terminal, and the first signal is sent by the second terminal through backscattering based on a signal transmission parameter; and
a processing module 231, configured to perform target processing on the second signal based on the signal transmission parameter.

According to the apparatus in this embodiment, the second terminal sends, through backscattering, the first signal to the first terminal based on the signal transmission parameter. The first terminal receives the first signal sent by a second terminal through backscattering based on the signal transmission parameter, and sends a second signal to a network side device. In other words, the second terminal performing backscattering can communicate with other devices. The receiving module receives the second signal sent by the first terminal, where the second signal is obtained based on the first signal. The processing module can perform target processing on the second signal based on the signal transmission parameter. According to the foregoing solution, communication between a BSC terminal, a relay terminal, and a base station in a bistatic backscatter communication architecture is implemented.

In some implementations, the apparatus further includes:
an obtaining module, configured to obtain the signal transmission parameter, where in some implementations, the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, periodicity length information of a preamble sequence, synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the obtaining module is further configured to:
obtain the signal transmission parameter in at least one of the following manners:
receiving fifth indication information sent by the second terminal, where the fifth indication information indicates the signal transmission parameter to the network side device; or
receiving sixth indication information sent by the first terminal, where the sixth indication information indicates the signal transmission parameter to the network side device; or
determining the signal transmission parameter.

In some implementations, the apparatus further includes:
a sending module, configured to send first indication information to the first terminal, where the first indication information indicates the signal transmission parameter to the first terminal; or
a sending module, configured to send second indication information to the second terminal, where the second indication information indicates the signal transmission parameter to the second terminal; or
a sending module, configured to send second indication information to the first terminal, where the second indication information indicates the signal transmission parameter to the first terminal.

In some implementations, the first indication information or the second indication information is carried in at least one of the following:
downlink control information DCI;
a preamble sequence;
radio resource control RRC signaling; or
a media access control control element MAC CE.

In some implementations, the fifth indication information or the sixth indication information is carried in at least one of the following:
two-step sidelink control information SCI;
one-step SCI;
a preamble sequence;
sidelink SL RRC signaling; or
a sidelink SL MAC CE.

The apparatus according to this embodiment can be used to perform the method in any one of the foregoing network side device-side method embodiments. The specific implementation process and technical effects of the apparatus in this embodiment are similar to those in the network side device-side method embodiments. For details, refer to the detailed description in the network side device-side method embodiment, which are not repeated herein.

The backscatter communication apparatus in this embodiment of this application may be an apparatus electronic device, such as an apparatus or an electronic device with an operating system, or a component in a terminal electronic device, such as an integrated circuit or a chip. The apparatus or the electronic device may be a mobile terminal or may be a non-mobile terminal device other than a terminal. For example, the mobile terminal may include, but is not limited to, the types of the terminal 11 listed above, and the non-mobile terminal device may be a server, a Network Attached Storage (NAS), a personal computer, a television, a teller machine, a self-service machine, or the like. This is not specifically limited in this embodiment of this application.

The backscatter communication apparatus provided in embodiments of this application can implement the processes implemented in the method embodiments of FIG. 11 to FIG. 18, and achieve the same technical effects. To avoid repetition, details are not described herein again.

In some implementations, as shown in FIG. 22, an embodiment of this application further provides a communication device 2200, including a processor 2201 and a memory 2202. The memory 2202 stores a program or instructions executable on the processor 2201. For example, when the communication device 2200 is a terminal, the program or the instructions, when executed by the processor 2201, implement the steps of the embodiments of the foregoing backscatter communication method, and can achieve the same technical effects. When the communication device 2200 is a network side device, the program or the instructions, when executed by the processor 2201, implement the steps of the embodiments of the foregoing backscatter communication method, and can achieve the same technical effects. To avoid repetition, details are not described herein again.

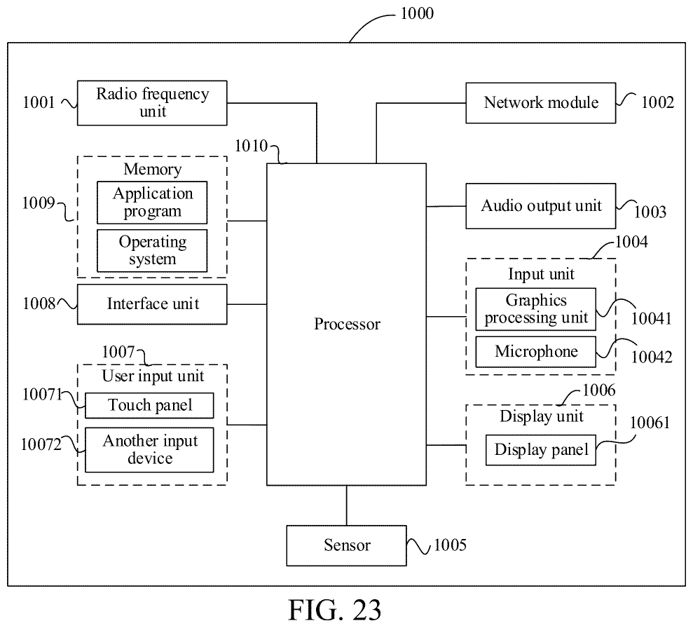

An embodiment of this application further provides a first terminal, including a processor and a communication interface, where the communication interface is configured to receive a first signal that is sent by a second terminal through backscattering based on a signal transmission parameter; and send a second signal to a network side device. The first terminal embodiment corresponds to the foregoing first terminal-side method embodiment. Each implementation process and implementation of the foregoing method embodiment can be applied to the first terminal embodiment, and can achieve the same technical effects. In some implementations, FIG. 23 is a schematic diagram of a hardware structure of a terminal according to an embodiment of this application.

The terminal 1000 includes, but is not limited to, at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include the power supply (for example, a battery) for supplying power to the components. The power supply may be logically connected to the processor 1010 by using a power management system, thereby implementing functions such as charging, discharging, and power consumption management by using the power management system. A terminal structure shown in FIG. 23 does not constitute a limitation to the terminal, and the terminal may include more or fewer components than those shown in the figure, or some components may be combined, or a different component deployment may be used. Details are not described herein again.

It should be understood that in embodiments of this application, the input unit 1004 may include a Graphics Processing Unit (GPU) 10041 and a microphone 10042, and the graphics processing unit 10041 processes image data of still images or videos obtained by an image capture apparatus (for example, a camera) in a video capture mode or an image capture mode. The display unit 1006 may include a display panel 10061, and the display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (for example, a volume control key or a switch key), a track ball, a mouse, and a joystick, which are not repeated herein.

In this embodiment of this application, the radio frequency unit 1001 receives downlink data from a network side device and then transmits the data to the processor 1010 for processing. In addition, the radio frequency unit 1001 may send uplink data to the network side device. Generally, the radio frequency unit 1001 includes, but is not limited to, an antenna, at least one amplifier, a transceiver, a coupler, a low noise amplifier, a duplexer, and the like.

The memory 1009 may be configured to store software programs or instructions, and various pieces of data. The memory 1009 may mainly include a first storage area storing a program or instructions and a second storage area storing data. The first storage area may store an operating system, an application program or instruction required by at least one function (for example, a sound playing function and an image playing function), and the like. In addition, the memory 1009 may include a volatile memory or a non-volatile memory, or the memory 1009 may include both a volatile and a non-volatile memory. The memory may include a high speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a SynchLink DRAM (SLDRAM), and a Direct Rambus RAM (DR RAM). The memory 1009 in this embodiment of this application includes, but is not limited to, such memories and any other suitable types of memories, for example, at least one magnetic disk storage device, a flash memory, or other volatile solid-state storage devices.

The processor 1010 may include one or more processing units. In some implementations, the processor 1010 integrates an application processor and a modem processor. The application processor mainly processes operations related to an operating system, a user interface, an application program or instructions, and the like. The modem processor mainly processes wireless communication signals, and may be, for example, a baseband processor. It may be understood that the foregoing modem processor may either not be integrated into the processor 1010.

The radio frequency unit 1001 is configured to receive a first signal that is sent by a second terminal through backscattering based on a signal transmission parameter; and
send a second signal to a network side device, where the second signal is obtained based on the first signal.

In the foregoing implementation solution, the second terminal sends, through backscattering, the first signal to the first terminal based on the signal transmission parameter. The radio frequency unit receives the first signal sent by a second terminal through backscattering based on the signal transmission parameter, and sends a second signal to a network side device. In other words, the second terminal performing backscattering can communicate with other devices. The network side device receives the second signal sent by the first terminal, where the second signal is obtained based on the first signal. The processor can perform target processing on the second signal based on the signal transmission parameter. According to the foregoing solution, communication between a BSC terminal, a relay terminal, and a base station in a bistatic backscatter communication architecture is implemented.

In some implementations, the radio frequency unit 1001 is further configured to obtain the signal transmission parameter, where the signal transmission parameter includes at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, preamble sequence synchronization information, a frequency shift parameter, an identifier of the second terminal, an identifier of the first terminal, a transmission identifier, or total transmission duration that is for a modulated signal, where
the time window indicates a time window in which the first signal is sent;
the synchronization information includes at least one of the following: starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

In some implementations, the radio frequency unit 1001 is further configured to:
obtain the signal transmission parameter in at least one of the following manners:
receiving first indication information sent by the network side device, where the first indication information indicates the signal transmission parameter to the first terminal; or
receiving second indication information sent by the network side device, where the second indication information indicates the signal transmission parameter to the second terminal, and the second indication information is information that both the first terminal and the second terminal can demodulate; or
receiving third indication information sent by the second terminal, where the third indication information indicates the signal transmission parameter to the first terminal; or
obtaining the signal transmission parameter determined by the processor 1010.

In the foregoing implementation, the first terminal can obtain the signal transmission parameter in various manners. This is highly flexible, and implementation complexity is low.

In some implementations, the first indication information or the second indication information is carried in at least one of the following:
downlink control information DCI;
a preamble sequence;
radio resource control RRC signaling; or
a media access control control element MAC CE.

In some implementations, the third indication information is carried in at least one of the following:
two-step sidelink control information SCI;
one-step SCI;
a preamble sequence;
sidelink SL RRC signaling; or
a sidelink SL MAC CE.

In some implementations, the radio frequency unit 1001 is further configured to:
demodulate and decode the first signal based on the signal transmission parameter, modulate and encode the decoded signal to generate the second signal, and send the second signal to the network side device; or
amplify the first signal to obtain the second signal, and send the second signal to the network side device.

In the foregoing implementation, the second signal sent by the first terminal to the network side device may be generated based on the first signal through amplification or parsing and then re-modulation and encoding. This is highly flexible, and the second signal generated through re-parsing is more reliable.

In some implementations, the second terminal is powered in at least one of the following manners:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

In the foregoing implementation, the second terminal can be powered in various manners. This is highly flexible, and can increase reliability of the device.

An embodiment of this application further provides a network side device, including a processor and a communication interface. The communication interface is configured to receive a second signal sent by a first terminal, where the second signal is obtained by the first terminal based on a first signal sent by a second terminal, and the first signal is sent by the second terminal through backscattering based on a signal transmission parameter; and the processor is configured to perform target processing on the second signal based on the signal transmission parameter. This network side device embodiment corresponds to the foregoing network side device method embodiment. Each implementation process and implementation of the foregoing method embodiment can be applied to this network side device embodiment, and can achieve the same technical effects.

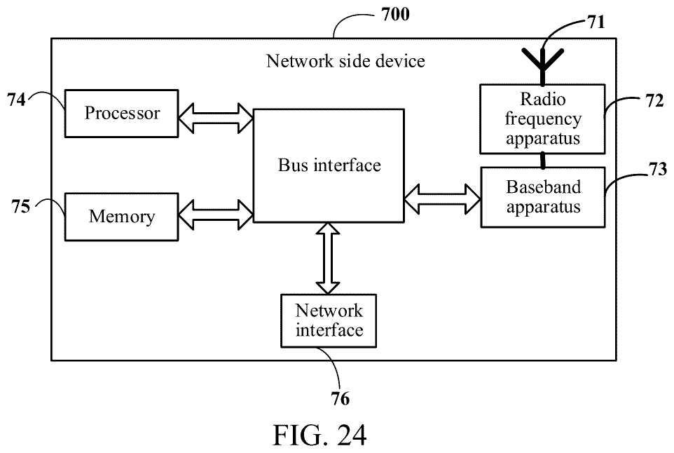

In some implementations, an embodiment of this application further provides a network side device. As shown in FIG. 24, the network side device 700 includes: an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information by using the antenna 71, and sends the received information to the baseband apparatus 73 for processing. In a downlink direction, the baseband apparatus 73 processes information to be sent, and sends the information to the radio frequency apparatus 72. The radio frequency apparatus 72 processes the received information and sends the information by using the antenna 71.

The backscatter communication apparatus may be located in the baseband apparatus 73, and the method performed by the network side device in the foregoing embodiment may be implemented in the baseband apparatus 73, where the baseband apparatus 73 includes a baseband processor 74 and a memory 75.

The baseband apparatus 73 may include, for example, at least one baseband plate. A plurality of chips are disposed on the baseband plate. As shown in FIG. 24, one of the plurality of chips is, for example, the baseband processor 74, and is connected to the memory 75 through a bus interface, to invoke a program in the memory 75 to perform operations of the network device in the foregoing method embodiment.

The network side device may further include a network interface 76, configured to exchange information with the radio frequency apparatus 72. The interface is, for example, a Common Public Radio Interface (CPRI).

In some implementations, the network side device 700 in this embodiment of the present invention further includes: instructions or a program stored in the memory 75 and executable on the processor 74. The processor 74 invokes the instructions or the program in the memory 75 to perform the method executed by each module shown in FIG. 21, and achieve the same technical effects. To avoid repetition, details are not repeated herein.

An embodiment of this application further provides a readable storage medium. The readable storage medium stores a program or instructions, where the program or the instructions, when executed by a processor, implement the processes of embodiments of the foregoing backscatter communication method, and achieve the same technical effects. To avoid repetition, details are not described herein again.

The processor is the processor in the terminal described in the foregoing embodiment. The readable storage medium includes a computer-readable storage medium such as a computer Read Only Memory (ROM), a Random Access Memory (RAM), a magnetic disk, or an optical disk.

An embodiment of this application further provides a chip, where the chip includes a processor and a communication interface, the communication interface is coupled to the processor, and the processor is configured to run a program or instructions, to implement the processes of embodiments of the foregoing backscatter communication method, and achieve the same technical effects. To avoid repetition, details are not described herein again.

It should be understood that, the chip described in this embodiment of this application may also be referred to as a system-level chip, a system chip, a chip system, a system on chip, or the like.

An embodiment of this application further provides a computer program/program product, stored in a storage medium, where the computer program/program product is executed by at least one processor to implement the processes of the embodiments of the foregoing backscatter communication method, and can achieve the same technical effects. To avoid repetition, details are not described herein again.

An embodiment of this application further provides a backscatter communication system, including: a first terminal, a second terminal, and a network side device. The first terminal may be configured to perform the steps of the backscatter communication method described above. The second terminal may be configured to perform the steps of the backscatter communication method described above. The network side device may be configured to perform the steps of the backscatter communication method described above.

It should be noted that the term “include,” “comprise” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses. Further, it should be noted that the scope of the method and the apparatus in the implementations of this application is not limited to performing the functions in the order shown or discussed, but may further include performing the functions in a substantially simultaneous manner or in the reverse order depending on the functions involved. For example, the described method may be performed in an order different from that described, and various steps may be further added, omitted, or combined. In addition, features described with reference to some examples may be combined in other examples.

Through the descriptions of the foregoing implementations, a person skilled in the art may clearly understand that the methods in the foregoing embodiments may be implemented via software and a necessary general hardware platform, and certainly, may also be implemented by hardware. Based on such an understanding, the technical solutions of this application essentially or the part contributing to the prior art may be implemented in a form of a computer software product. The computer software product is stored in a storage medium (for example, a ROM/RAM, a magnetic disk, or an optical disc) and includes several instructions for instructing a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. A backscatter communication method, performed by a first terminal, comprising:
receiving a first signal that is sent by a second terminal through backscattering based on a signal transmission parameter; and
sending a second signal to a network side device, wherein the second signal is obtained based on the first signal.

2. The backscatter communication method according to claim 1, further comprising:
obtaining the signal transmission parameter, wherein the signal transmission parameter comprises at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, preamble sequence synchronization information, a frequency shift parameter, an identifier of the second terminal, an identifier of the first terminal, a transmission identifier, or total transmission duration that is for a modulated signal, wherein:
the time window indicates a time window in which the first signal is sent;
the synchronization information comprises at least one of the following: starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

3. The backscatter communication method according to claim 2, wherein the obtaining the signal transmission parameter comprises:
obtaining the signal transmission parameter in at least one of the following:
receiving first indication information sent by the network side device, wherein the first indication information indicates the signal transmission parameter to the first terminal;
receiving second indication information sent by the network side device, wherein the second indication information indicates the signal transmission parameter to the second terminal, and the second indication information is information that both the first terminal and the second terminal are configured to demodulate;
receiving third indication information sent by the second terminal, wherein the third indication information indicates the signal transmission parameter to the first terminal; or
determining the signal transmission parameter.

4. The backscatter communication method according to claim 3, wherein:
the first indication information or the second indication information is carried in at least one of the following:
Downlink Control Information (DCI);
a preamble sequence;
Radio Resource Control (RRC) signaling; or
a Media Access Control Control Element (MAC CE).

5. The backscatter communication method according to claim 3, wherein the third indication information is carried in at least one of the following:
two-step Sidelink Control Information (SCI);
one-step SCI;
a preamble sequence;
SideLink Radio Resource Control (SL RRC) signaling; or
a SideLink Media Access Control Control Element (SL MAC CE).

6. The backscatter communication method according to claim 1, wherein the sending a second signal to a network side device comprises:
demodulating and decoding the first signal based on the signal transmission parameter to obtain a third signal, modulating and encoding the third signal to generate the second signal, and sending the second signal to the network side device; or
amplifying the first signal to obtain the second signal, and sending the second signal to the network side device.

7. The backscatter communication method according to claim 1, wherein the second terminal is powered in at least one of the following:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

8. A backscatter communication method, performed by a second terminal, comprising:
sending, through backscattering, a first signal to a first terminal based on a signal transmission parameter.

9. The backscatter communication method according to claim 8, further comprising:
obtaining the signal transmission parameter, wherein the signal transmission parameter comprises at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, preamble sequence synchronization information, a frequency shift parameter, an identifier of the second terminal, an identifier of the first terminal, a transmission identifier, or total transmission duration that is for a modulated signal, wherein:
the time window indicates a time window in which the first signal is sent;
the synchronization information comprises at least one of the following: starting time of a subframe or a symbol of the first signal, or information about an offset between a timing of the first signal and a timing of a network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

10. The backscatter communication method according to claim 9, wherein the obtaining the signal transmission parameter comprises:
obtaining the signal transmission parameter in at least one of the following:
receiving second indication information sent by the network side device, wherein the second indication information indicates the signal transmission parameter to the second terminal, and the second indication information is information that both the first terminal and the second terminal are configured to demodulate;
receiving fourth indication information sent by the first terminal, wherein the fourth indication information indicates the signal transmission parameter to the second terminal; or
determining the signal transmission parameter.

11. The backscatter communication method according to claim 8, further comprising:
sending third indication information to the first terminal, wherein the third indication information indicates the signal transmission parameter to the first terminal.

12. The backscatter communication method according to claim 10, wherein the second indication information is carried in at least one of the following:
Downlink Control Information (DCI);
a preamble sequence;
Radio Resource Control (RRC) signaling; or
a Media Access Control Control Element (MAC CE), wherein the fourth indication information is carried in at least one of the following:
two-step Sidelink Control Information (SCI);
one-step SCI;
a preamble sequence;
SideLink Radio Resource Control (SL RRC) signaling; or
a SideLink Media Access Control Control Element (SL MAC CE).

13. The backscatter communication method according to claim 11, wherein the third indication information is carried in at least one of the following:
two-step Sidelink Control Information (SCI);
one-step SCI;
a preamble sequence;
SideLink Radio Resource Control (SL RRC) signaling; or
a SideLink Media Access Control Control Element (SL MAC CE).

14. The backscatter communication method according to claim 8, wherein the second terminal is powered in at least one of the following:
the second terminal is powered by a radio frequency signal transmitted by the network side device;
the second terminal is powered by a radio frequency signal transmitted by another device;
the second terminal is powered by a mechanical power supply;
the second terminal is powered by a vibration power supply;
the second terminal is powered by solar energy; or
the second terminal is powered by thermal energy.

15. A backscatter communication method, performed by a network side device, comprising:
receiving a second signal sent by a first terminal, wherein the second signal is obtained by the first terminal based on a first signal sent by a second terminal, and the first signal is sent by the second terminal through backscattering based on a signal transmission parameter; and
performing target processing on the second signal based on the signal transmission parameter.

16. The backscatter communication method according to claim 15, further comprising:
obtaining the signal transmission parameter, wherein the signal transmission parameter comprises at least one of the following:
a time domain resource, a frequency domain resource, a time window, a precoding parameter, a space-time code parameter, an aperiodic transmission mode, periodicity length information, time information of signal transmission within a transmission periodicity, a modulation method, a coding method, a delimiter, preamble sequence synchronization information, a frequency shift parameter, an identifier of the second terminal, an identifier of the first terminal, a transmission identifier, or total transmission duration that is for a modulated signal, wherein:
the time window indicates a time window in which the first signal is sent;
the synchronization information comprises at least one of the following: starting time of a subframe or a symbol of the first signal, or information about an offset between a timing of the first signal and a timing of the network side device;
the delimiter indicates a starting moment of the first signal;
the preamble sequence indicates information related to signal frame synchronization of the first signal;
the frequency shift parameter indicates parameter information for frequency shifting the first signal;
the transmission identifier indicates whether the first signal is transmitted periodically; and
the total transmission duration indicates total duration for transmission of the first signal.

17. The backscatter communication method according to claim 16, wherein the obtaining the signal transmission parameter comprises:
obtaining the signal transmission parameter in at least one of the following:
receiving fifth indication information sent by the second terminal, wherein the fifth indication information indicates the signal transmission parameter to the network side device;
receiving sixth indication information sent by the first terminal, wherein the sixth indication information indicates the signal transmission parameter to the network side device; or
determining the signal transmission parameter.

18. The backscatter communication method according to claim 15, further comprising:
sending first indication information to the first terminal, wherein the first indication information indicates the signal transmission parameter to the first terminal;
sending second indication information to the second terminal, wherein the second indication information indicates the signal transmission parameter to the second terminal; or
sending second indication information to the first terminal, wherein the second indication information indicates the signal transmission parameter to the first terminal.

19. The backscatter communication method according to claim 18, wherein the first indication information or the second indication information is carried in at least one of the following:
Downlink Control Information (DCI);
a preamble sequence;
Radio Resource Control (RRC) signaling; or
a Media Access Control Control Element (MAC CE).

20. The backscatter communication method according to claim 17, wherein the fifth indication information or the sixth indication information is carried in at least one of the following:
two-step Sidelink Control Information (SCI);
one-step SCI;
a preamble sequence;
SideLink Radio Resource Control (SL RRC) signaling; or
a SideLink Media Access Control Control Element (SL MAC CE).
